(19) United States
(12) Patent Application Publication
(10) Pub. No.: US 2026/0336859 A1
(43) Pub. Date: Oct. 29, 2026

(54) TRAY, METHOD OF MANUFACTURING THE TRAY, AND ELECTRONIC DEVICE STORED IN THE TRAY

(71) Applicant: Samsung Display Co., LTD., Yongin-si (KR)

(72) Inventors: KYUNGJO LEE, Yongin-si (KR); HONGJU KIM, Yongin-si (KR); EUIYOUNG KIM, Yongin-si (KR); NAMPYO HONG, Yongin-si (KR)

(21) Appl. No.: 19/331,394

(22) Filed: Sep. 17, 2025

(30) Foreign Application Priority Data
Apr. 24, 2025 (KR) 10-2025-0053616

(51) Int. Cl. B65D 1/36; B29D 22/00; B65D 85/30

(52) U.S. Cl. CPC B65D 1/36; B29D 22/003; B65D 85/30

(57) ABSTRACT

A tray includes: a bottom portion including a first bottom protrusion portion protruding in a first direction and a second bottom protrusion portion protruding in the first direction and spaced apart from the first bottom protrusion portion in a second direction crossing the first direction, a first side portion connected to one side of the bottom portion, the first side portion including a 1-1 side protrusion portion protruding in a third direction crossing the first direction and a 1-2 side protrusion portion spaced apart from the 1-1 side protrusion portion in the second direction, and a second side portion connected to another side of the bottom portion spaced apart from the one side of the bottom portion, the second side portion including a 2-1 side protrusion portion protruding in a direction opposite to the third direction and a 2-2 side protrusion portion spaced apart from the 2-1 side protrusion portion.

This application claims priority to Korean Patent Application No. 10-2025-0053616, filed on Apr.24, 2025, and all the benefits accruing therefrom under 35 U.S.C. §119, the content of which in its entirety is herein incorporated by reference.

### BACKGROUND

### 1. Field

The present disclosure relates to a tray, a method of manufacturing the tray, and an electronic device stored in the tray. More particularly, the present disclosure relates to a tray accommodating an object, a method of manufacturing the tray, and an electronic device stored in the tray.

### 2. DESCRIPTION OF THE RELATED ART

With the development of multimedia, the importance of display devices is increasing. In response, various types of display devices, such as an organic light emitting display (“OLED”), a liquid crystal display (“LCD”), and/or the like, are being used.

After manufacturing the display device, during a process such as transportation, the display device may be accommodated by a tray and/or the like. Approaches in which the tray efficiently accommodates the display device in terms of space and safely protects the display device from external impact and/or the like are desired. However, as the size of display devices and/or the like has recently increased, research with respect to a suitable tray and/or the like capable of accommodating the same is ongoing.

### SUMMARY

Embodiments of the present disclosure provide a tray having improved space efficiency and improved safety.

Embodiments of the present disclosure provide a method of manufacturing the tray.

Embodiments of the present disclosure provide an electronic device stored in the tray.

A tray according to embodiments accommodates a display device and includes a bottom portion including a first bottom protrusion portion protruding in a first direction in a plan view and a second bottom protrusion portion protruding in the first direction and spaced apart from the first bottom protrusion portion in a second direction crossing the first direction in the plan view, a first side portion connected to one side of the bottom portion, the first side portion including a 1-1 side protrusion portion protruding in a third direction crossing the first direction and a 1-2 side protrusion portion spaced apart from the 1-1 side protrusion portion in the second direction, and a second side portion connected to another side of the bottom portion spaced apart from the one side of the bottom portion, the second side portion including a 2-1 side protrusion portion protruding in a direction opposite to the third direction and a 2-2 side protrusion portion spaced apart from the 2-1 side protrusion portion in the second direction.

In embodiments, the first bottom protrusion portion and the second bottom protrusion portion may be spaced apart from each other in a diagonal direction in the plan view.

In embodiments, a first separation distance by which the first bottom protrusion portion and the second bottom protrusion portion are spaced apart in the second direction may be equal to or less than about 2.5 mm.

In embodiments, the 1-1 side protrusion portion and the 1-2 side protrusion portion may be spaced apart by a second separation distance in the second direction, and the 2-1 side protrusion portion and the 2-2 side protrusion portion may be spaced apart by a third separation distance in the second direction.

In embodiments, the first separation distance, the second separation distance, and the third separation distance may be substantially equal to each other.

In embodiments, the bottom portion may further include a third bottom protrusion portion which is spaced apart from the second bottom protrusion portion in the second direction and parallel to the first bottom protrusion portion along the second direction.

In embodiments, the third bottom protrusion portion may be spaced apart from the second bottom protrusion portion by the first separation distance in the second direction.

In embodiments, a height of each of the first side portion and the second side portion in the first direction may be equal to or more than about 50% of a length of one side of the display device.

In embodiments, the bottom portion, the first side portion, and the second side portion may be integrally formed.

In embodiments, the tray may further include a body portion located below the bottom portion and covering the bottom portion, the first side portion, and the second side portion

In embodiments, the bottom portion, the first side portion, the second side portion, and the body portion may include plastic.

In embodiments, each of the first bottom protrusion portion and the second bottom protrusion portion may have a chamfered corner in the plan view.

In embodiments, the tray may accommodate the display device between the first bottom protrusion portion and the second bottom protrusion portion.

A method of manufacturing a tray according to embodiments includes providing a main body portion including a first area, a second area located adjacent to one side of the first area, and a third area located adjacent to another side of the first area, forming a first bottom protrusion portion, a 1-1 side protrusion portion, and a 2-1 side protrusion portion in the first area, the second area, and the third area of the main body portion, respectively, wherein the first bottom protrusion portion, the 1-1 side protrusion portion, and the 2-1 side protrusion portion are parallel to each other along a first direction, forming a second bottom protrusion portion in the first area of the main body portion, the second bottom protrusion portion being spaced apart from the first bottom protrusion portion in a second direction crossing the first direction, forming a 1-2 side protrusion portion in the second area of the main body portion, the 1-2 side protrusion portion being spaced apart from the 1-1 side protrusion portion in the second direction, forming a 2-2 side protrusion portion in the third area of the main body portion, the 2-2 side protrusion portion being spaced apart from the 2-1 side protrusion portion in the second direction, and folding the main body portion along a first folding line dividing the first area and the second area and a second folding line dividing the first area and the third area.

In embodiments, based on the folding of the main body portion, the first area of the main body portion may be formed into a bottom portion, the second area of the main body portion may be formed into a first side portion, and the third area of the main body portion may be formed into a second side portion facing the first side portion.

In embodiments, the forming of the first bottom protrusion portion, the second bottom protrusion portion, the 1-1 side protrusion portion, the 1-2 side protrusion portion, the 2-1 side protrusion portion, and the 2-2 side protrusion portion may include a mold-forming process.

In embodiments, based on the mold-forming process, each of the first bottom protrusion portion, the second bottom protrusion portion, the 1-1 side protrusion portion, the 1-2 side protrusion portion, the 2-1 side protrusion portion, and the 2-2 side protrusion portion may have a shape with a chamfered corner in a plan view.

In embodiments, based on the mold-forming process, the first bottom protrusion portion and the second bottom protrusion portion may be spaced apart by a first separation distance in the second direction, the 1-1 side protrusion portion and the 1-2 side protrusion portion may be spaced apart by a second separation distance in the second direction, and the 2-1 side protrusion portion and the 2-2 side protrusion portion are spaced apart by a third separation distance in the second direction.

In embodiments, each of the first separation distance, the second separation distance, and the third separation distance may be equal to or less than about 2.5 mm.

An electronic device according to embodiments includes a display device and a processor driving the display device.

In embodiments, the display device may be accommodated by a tray.

In embodiments, the tray may include a bottom portion including a first bottom protrusion portion protruding in a first direction and a second bottom protrusion portion protruding in the first direction and spaced apart from the first bottom protrusion portion in a second direction crossing the first direction in a plan view, a first side portion connected to one side of the bottom portion, the first side portion including a 1-1 side protrusion portion protruding in a third direction crossing the first direction and a 1-2 side protrusion portion spaced apart from the 1-1 side protrusion portion in the second direction, and a second side portion connected to another side of the bottom portion spaced apart from the one side of the bottom portion, the second side portion including a 2-1 side protrusion portion protruding in a direction opposite to the third direction and a 2-2 side protrusion portion spaced apart from the 2-1 side protrusion portion in the second direction.

A tray according to embodiments may accommodate a display device and include a bottom portion including a first bottom protrusion portion protruding in a first direction and a second bottom protrusion portion protruding in the first direction and spaced apart from the first bottom protrusion portion in a second direction crossing the first direction in a plan view, a first side portion connected to one side of the bottom portion, the first side portion including a 1-1 side protrusion portion protruding in a third direction crossing the first direction and a 1-2 side protrusion portion spaced apart from the 1-1 side protrusion portion in the second direction, and a second side portion connected to another side of the bottom portion spaced apart from the one side of the bottom portion, the second side portion including a 2-1 side protrusion portion protruding in a direction opposite to the third direction and a 2-2 side protrusion portion spaced apart from the 2-1 side protrusion portion in the second direction.

Accordingly, a display panel may be accommodated by protrusion portions formed in the tray. Before folding is applied to the tray, the protrusion portions are formed in the main body portion to allow adjustment of heights of side portions, such that a size (e.g., a size of one side) of the display panel accommodated by the tray is not restricted. In some aspects, as the protrusion portions are formed in a diagonal direction in a plan view, distance constraints between the protrusion portions are minimized, whereby even when the display panel has a small thickness, the display panel may be stably accommodated by the tray.

### BRIEF DESCRIPTION OF THE DRAWINGS

Illustrative, non-limiting embodiments will be more clearly understood from the following detailed description in conjunction with the accompanying drawings.

FIG. 1 is a perspective view illustrating a tray according to embodiments.

FIGS. 2, 3, 4, and 5, are views illustrating a method of molding a main body portion of the tray of FIG. 1.

FIGS. 6, 7, 8, 9, and 10, are views illustrating a method of manufacturing the tray including the main body portion of FIG. 5.

FIG. 11 is a perspective view illustrating embodiments in which a display panel is accommodated by the main body portion illustrated in FIG. 7.

FIG. 12 is a perspective view illustrating a tray including a cap portion located on the display panel of FIG. 11.

FIG. 13 is a plan view illustrating embodiments of an upper surface of a folded tray.

FIG. 14 is a plan view illustrating embodiments in which a display panel is accommodated by the tray of FIG. 13.

FIG. 15 is a block diagram illustrating an electronic device according to embodiments.

FIG. 16 is a schematic diagram of an electronic device according to various embodiments.

### DETAILED DESCRIPTION

Regarding embodiments of the present disclosure disclosed in this text, specific structural and functional descriptions are illustrative for a purpose of explaining the embodiments of the present disclosure, and the embodiments of the present disclosure may be implemented in various forms and should not be construed as limited to the embodiments described in.

Since the present disclosure may be subject to various changes and may have various forms, specific embodiments will be illustrated in the drawings and described in detail in the text. However, this is not intended to limit the present disclosure to a specific disclosed form, and should be understood to include all changes, equivalents, and substitutes included in the spirit and technical scope of the present disclosure.

Terms such as first, second, and the like may be used to describe various components, but the components should not be limited by the terms. The above terms may be used for a purpose of distinguishing one component from another component. For example, a first component may be referred to as a second component, and similarly, the second component may be referred to as a first component without departing from the scope of the present disclosure.

The terms “about” or “approximately” as used herein are inclusive of the stated value and include a suitable range of deviation for the particular value as determined by one of ordinary skill in the art, considering the measurement in question and the error associated with measurement of the particular quantity. The terms “about” or “approximately” can mean within one or more standard deviations, or within ± 30%, 20%, 10%, 5% of the stated value, for example.

The term “substantially,” as used herein, means approximately or actually. The term “substantially equal” means approximately or actually equal. The term “substantially the same” means approximately or actually the same. The term “substantially perpendicular” means approximately or actually perpendicular. The term “substantially parallel” means approximately or actually parallel.

It will be understood that when an element is referred to as being “connected” or “coupled” to another element, it may be directly connected or coupled to the other element or intervening element(s) may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for a purpose of describing particular example embodiments and is not intended to be limiting of the embodiments of the present disclosure. As used herein, the singular forms “a,” “an” and “the” are intended to include plural forms as well, unless the context clearly indicates otherwise. It will be further understood that the terms “comprises” and/or “comprising,” when used in this specification, specify a presence of stated features, integers, steps, operations, elements, and/or components, but do not preclude the presence or addition of one or more other features, integers, steps, operations, elements, components, and/or groups thereof.

Terms such as “below”, “at the bottom”, “lower”, “below”, “above”, “on top”, “on the top”, “on”, and the like are used to explain a relationship between components illustrated in the drawings. The terms are relative concepts and are explained based on the direction indicated in the drawings.

Unless otherwise defined, all terms (including technical and scientific terms) used herein have a same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. Same reference numerals are used for same components in the drawings, and redundant descriptions of same components will be omitted.

In this specification, a plane may be defined by a first direction D1 and a second direction D2 that intersects the first direction D1. For example, the second direction D2 may be perpendicular to the first direction D1. In some aspects, a third direction D3 may be a normal direction of the plane. That is, the third direction D3 may be perpendicular to the plane formed by the first direction D1 and the second direction D2.

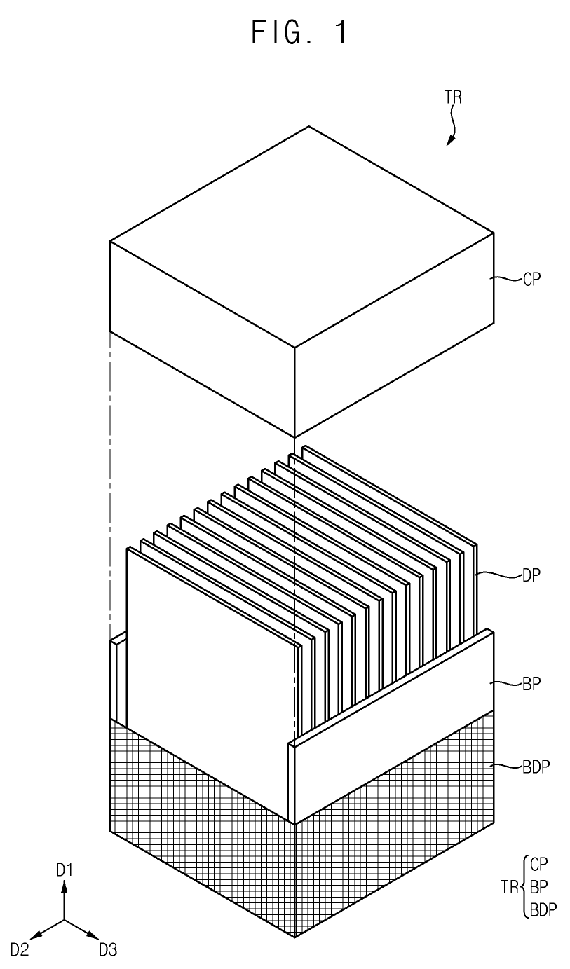

FIG. 1 is a perspective view illustrating a tray according to embodiments.

Referring to FIG. 1, the tray TR may include a main body portion BP, a body portion BDP, and a cap portion CP.

The main body portion BP may accommodate a plurality of display panels DP. The display panels DP may be accommodated by the main body portion BP in plurality along the second direction D2. For example, the display panels DP may be inserted into the main body portion BP along the second direction D2, and the main body portion BP may fix the display panels DP such that the display panels DP do not collide with each other.

As illustrated in FIG. 1, the display panels DP may be arranged to form a single row along the second direction D2, but embodiments of the present disclosure are not limited thereto. In some embodiments, depending on a size, a shape, and/or the like of the tray TR, the display panels DP may be arranged to form two or more rows in the tray TR.

The display panels DP may have a rectangular shape or a square shape in a plan view. For example, each of the display panels DP may have a long side extending in the first direction D1 and a short side extending in the third direction D3.

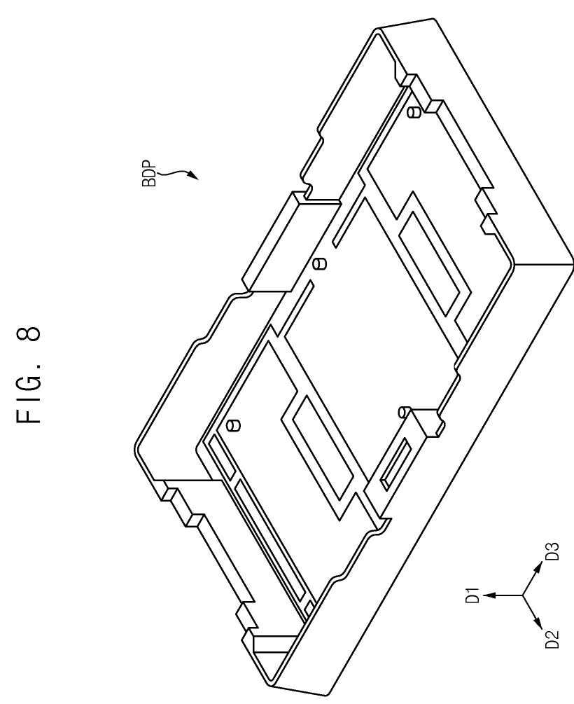

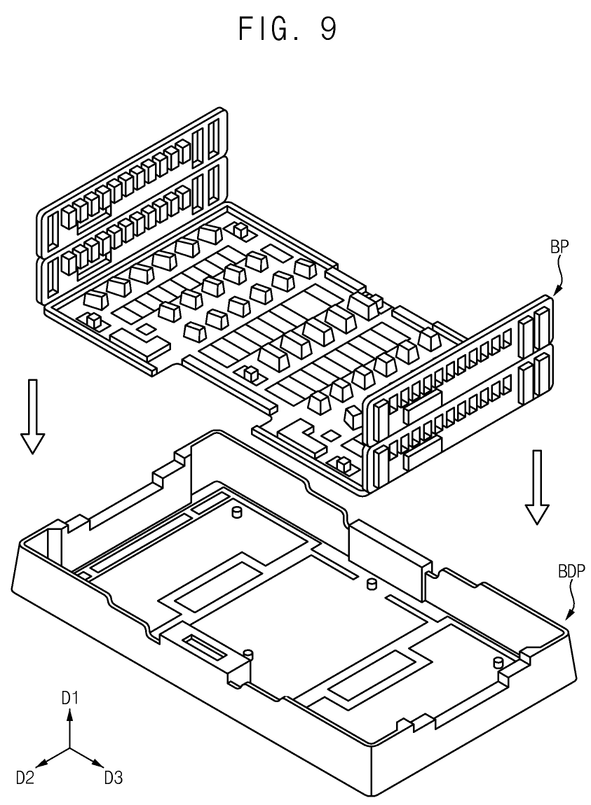

The body portion BDP may cover a side surface of the main body portion BP. By the body portion BDP covering the side surface of the main body portion BP, the side surface of the main body portion BP may be fixed along the first direction D1. Embodiments in which the body portion BDP fixes the main body portion BP will be described later with reference to FIGS. 9 and 10.

The cap portion CP may cover an upper portion of the display panel DP. For example, the cap portion CP may cover the upper portion of the display panel DP accommodated by the main body portion BP and protect the display panel DP from external foreign substances, impact, and/or the like. However, the cap portion CP may be omitted.

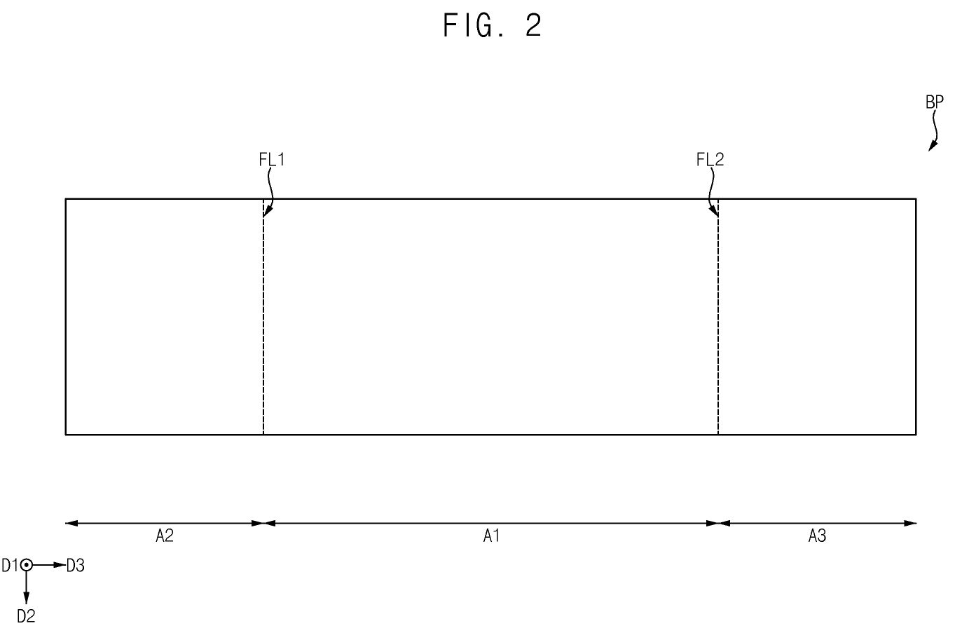

FIGS. 2, 3, 4, and 5, are views illustrating a method of molding a main body portion of the tray of FIG. 1.

Referring to FIG. 2, the main body portion BP may have a rectangular shape in the plan view. For example, the main body portion BP may have a rectangular shape including a long side extending in the third direction D3 and a short side extending in the second direction D2. The main body portion BP may also have a square shape, a shape with chamfered corners, a shape with rounded corners, and/or the like in the plan view. For example, the main body portion BP may include plastic. However, embodiments of the present disclosure are not limited thereto.

The main body portion BP may include a first area A1, a second area A2, and a third area A3 in the plan view. As illustrated in FIG. 2, the second area A2 may be directly adjacent to the first area A1 in a direction opposite to the third direction D3. The third area A3 may be directly adjacent to the first area A1 in the third direction D3. For example, the second area A2 may be directly adjacent to one side of the first area A1, and the third area A3 may be directly adjacent to the other side of the first area A1 spaced apart from the one side of the first area A1. For example, the third area A3 may be spaced apart from the second area A2 in the third direction D3, and the first area A1 may be disposed between the second area A2 and the third area A3.

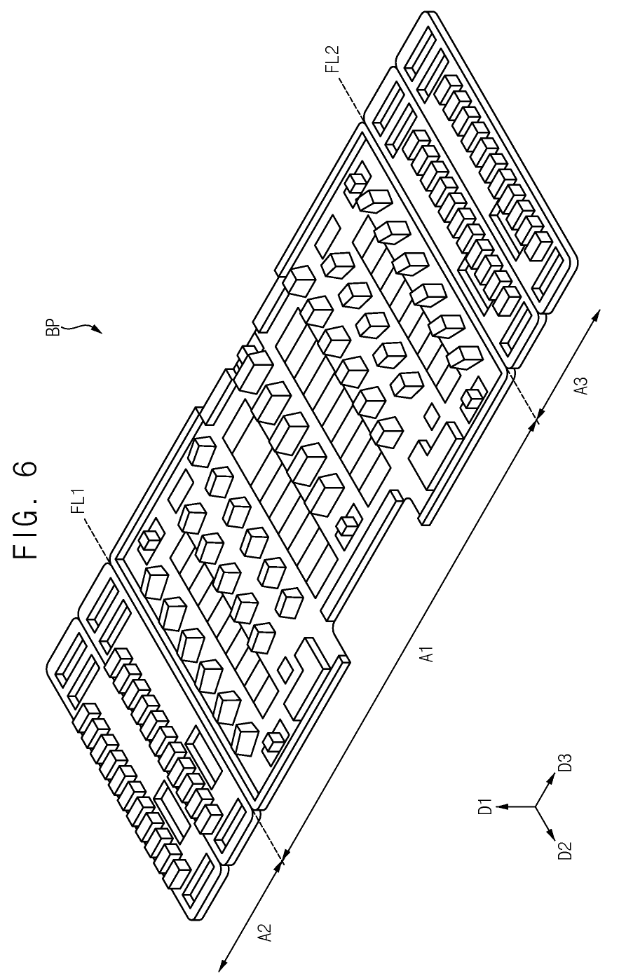

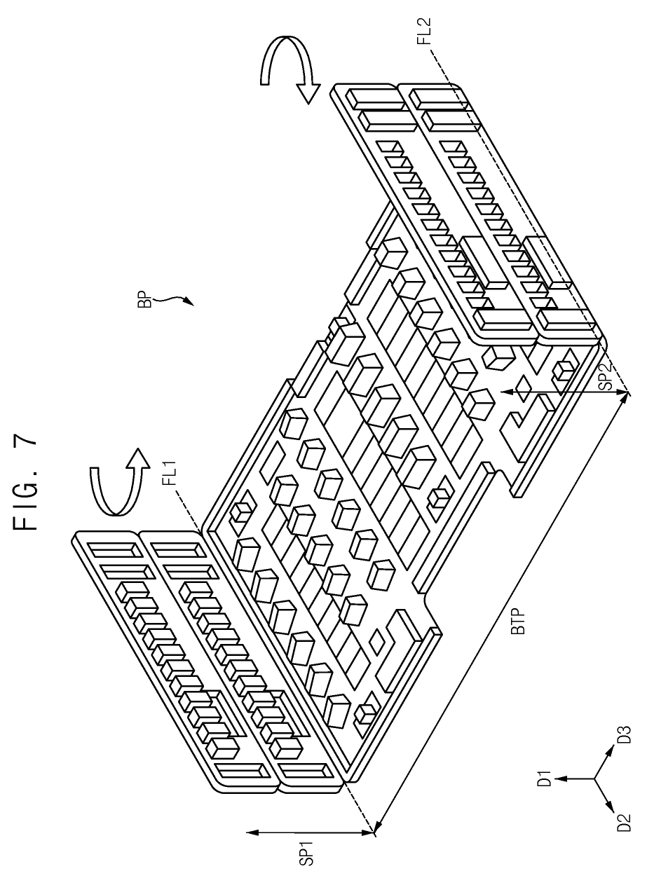

In embodiments, a first folding line FL1 extending in the second direction D2 may be defined between the first area A1 and the second area A2. A second folding line FL2 extending in the second direction D2 may be defined between the first area A1 and the third area A3. Embodiments in which the main body portion BP is folded along the first folding line FL1 and the second folding line FL2 will be described herein with reference to FIGS. 6 and 7.

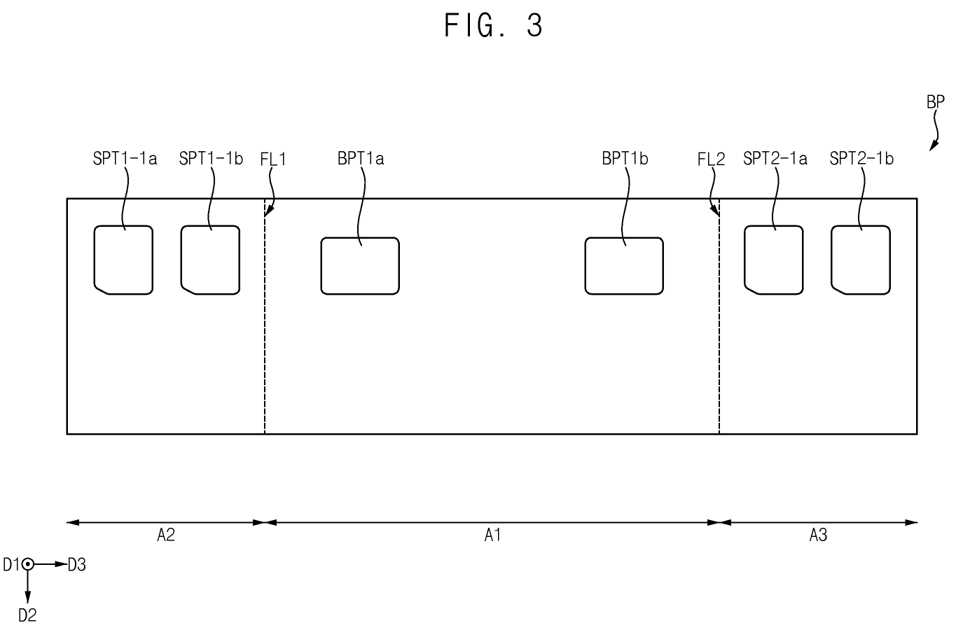

Referring further to FIG. 3, protrusion portions may be formed in the main body portion BP. For example, in the first area A1 of the main body portion BP, first bottom protrusion portions BPT1a and BPT1b may be formed along the third direction D3. In the second area A2 of the main body portion BP, 1-1 side protrusion portions SPT1-1a and SPT1-1b may be formed along the third direction D3. In the third area A3 of the main body portion BP, 2-1 side protrusion portions SPT2-1a and SPT2-1b may be formed along the third direction D3.

In embodiments, the first bottom protrusion portions BPT1a and BPT1b may be spaced apart from each other in the third direction D3, the 1-1 side protrusion portions SPT1-1a and SPT1-1b may be spaced apart from each other in the third direction D3, and the 2-1 side protrusion portions SPT2-1a and SPT2-1b may be spaced apart from each other in the third direction D3. As illustrated in FIG. 3, two of the first bottom protrusion portions BPT1a and BPT1b may be formed, but embodiments of the present disclosure are not limited thereto, and the number of the first bottom protrusion portions BPT1a and BPT1b may be one or three or more. For example, the first area A1 may include a single first bottom protrusion portion BPT1a (or BPT1b), or the third area A3 may include multiple first bottom protrusion portions BPT1a, BPT1b, and BPT1c (not illustrated).

As illustrated in FIG. 3, two of the 1-1 side protrusion portions SPT1-1a and SPT1-1b may be formed, but embodiments of the present disclosure are not limited thereto, and the number of the 1-1 side protrusion portions SPT1-1a and SPT1-1b may be one or three or more. For example, the second area A2 may include a single 1-1 side protrusion portion SPT1-1a (or SPT1-1b), or the second area A2 may include multiple 1-1 side protrusion portions SPT1-1a, SPT1-1b, and SPT1-1c (not illustrated).

As illustrated in FIG. 3, two of the 2-1 side protrusion portions SPT2-1a and SPT2-1bmay be formed, but embodiments of the present disclosure are not limited thereto, and the number of the 2-1 side protrusion portions SPT2-1a and SPT2-1b may be one or three or more. For example, the third area A3 may include a single 2-1 side protrusion portion SPT2-1a (or SPT2-1b), or the third area A3 may include multiple 2-1 side protrusion portions SPT2-1a, SPT2-1b, and SPT2-1c (not illustrated).

In embodiments, each of the first bottom protrusion portions BPT1a and BPT1b, the 1-1 side protrusion portions SPT1-1a and SPT1-1b, and the 2-1 side protrusion portions SPT2-1a and SPT2-1b may be formed through a mold-forming process. For example, the first bottom protrusion portions BPT1a and BPT1b, the 1-1 side protrusion portions SPT1-1a and SPT1-1b, and the 2-1 side protrusion portions SPT2-1a and SPT2-1b may be formed in the main body portion BP by applying pressure to the main body portion BP against a mold having shapes of the protrusion portions. However, embodiments of the present disclosure are not limited thereto.

In embodiments, each of the first bottom protrusion portions BPT1a and BPT1b, the 1-1 side protrusion portions SPT1-1a and SPT1-1b, and the 2-1 side protrusion portions SPT2-1a and SPT2-1b may have a shape in which a chamfered shape or a rounded shape is applied to corner portions in the plan view. For example, each of the first bottom protrusion portions BPT1a and BPT1b, the 1-1 side protrusion portions SPT1-1a and SPT1-1b, and the 2-1 side protrusion portions SPT2-1a and SPT2-1b may have chamfered or rounded corners. As each of the first bottom protrusion portions BPT1a and BPT1b, the 1-1 side protrusion portions SPT1-1a and SPT1-1b, and the 2-1 side protrusion portions SPT2-1a and SPT2-1b has chamfered corners or rounded corners, damage to the display panel DP by the protrusion portions may be prevented or reduced when the display panel DP is inserted into the main body portion BP. However, embodiments of the present disclosure are not limited thereto, and shapes in the plan view of the first bottom protrusion portions BPT1a and BPT1b, the 1-1 side protrusion portions SPT1-1a and SPT1-1b, and the 2-1 side protrusion portions SPT2-1a and SPT2-1b may vary depending on embodiments.

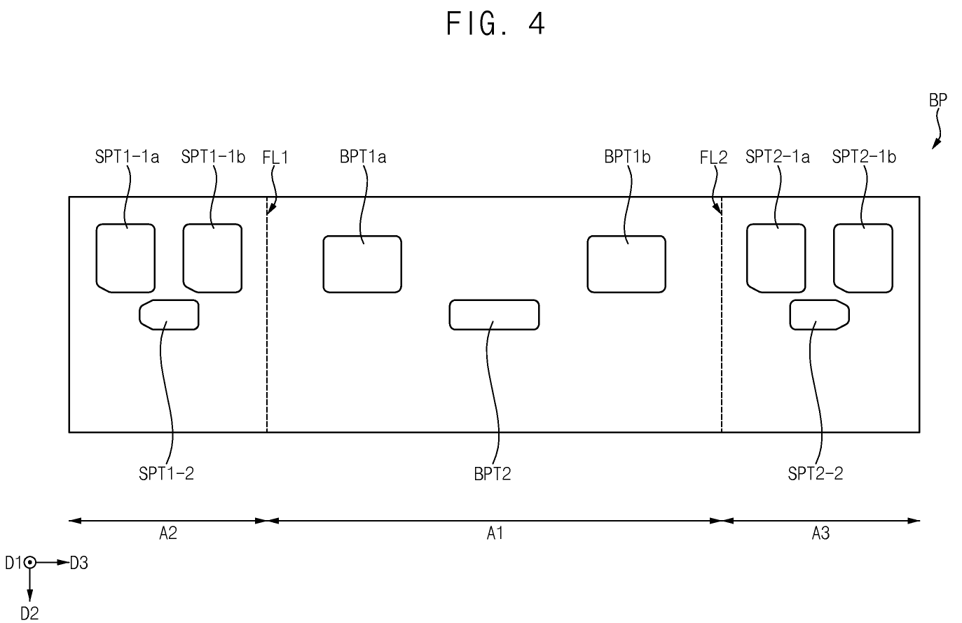

Referring further to FIG. 4, a second bottom protrusion portion BPT2 may be formed in the first area A1, a 1-2 side protrusion portion SPT1-2 may be formed in the second area A2, and a 2-2 side protrusion portion SPT2-2 may be formed in the third area A3. As illustrated in FIG. 4, one of each of the second bottom protrusion portion BPT2, the 1-2 side protrusion portion SPT1-2, and the 2-2 side protrusion portion SPT2-2 may be formed. However, embodiments of the present disclosure are not limited thereto, and the number of each of the second bottom protrusion portion BPT2, the 1-2 side protrusion portion SPT1-2, and the 2-2 side protrusion portion SPT2-2 may vary depending on embodiments.

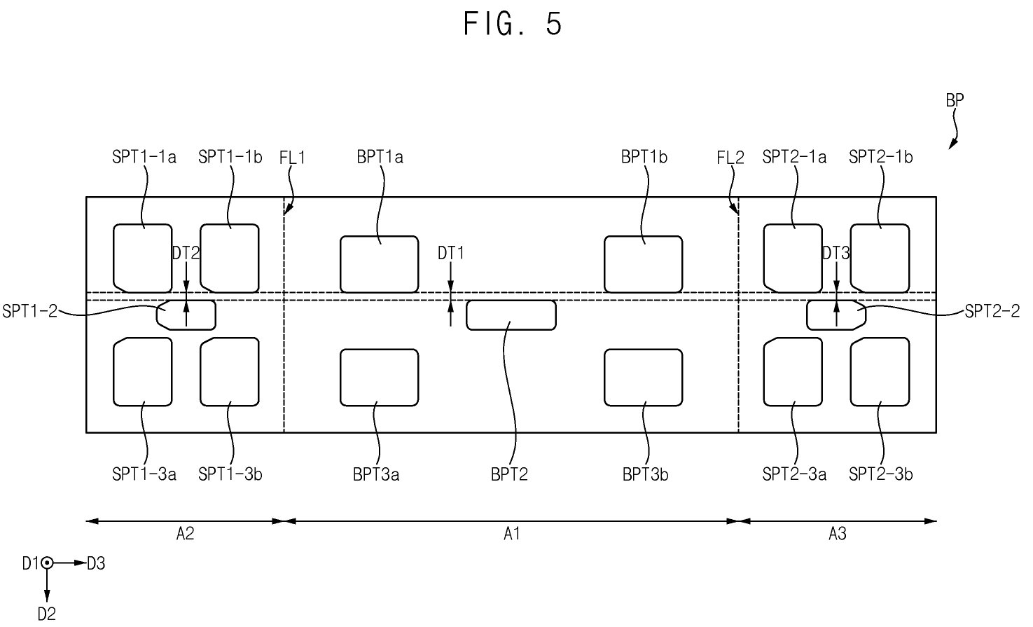

In embodiments, the first bottom protrusion portions BPT1a and BPT1b may each be spaced apart from the second bottom protrusion portion BPT2 in a diagonal direction in the plan view. For example, the first bottom protrusion portions BPT1a and BPT1b may each be spaced apart from the second bottom protrusion portion BPT2 in a diagonal direction extending in a vector direction obtained by adding the second direction D2 and the third direction D3, or in a vector direction obtained by adding the second direction D2 and a opposite direction of the third direction D3. As the first bottom protrusion portions BPT1a and BPT1b and the second bottom protrusion portion BPT2 are spaced apart in a diagonal direction, a first separation distance (e.g., a first separation distance DT1 of FIG. 5) in the second direction D2 between the first bottom protrusion portions BPT1a and BPT1b and the second bottom protrusion portion BPT2 may be minimized. In a comparative example in which the first bottom protrusion portions BPT1a and BPT1b and the second bottom protrusion portion BPT2 are not spaced apart in a diagonal direction in the plan view, the first separation distance (e.g., the first separation distance DT1 of FIG. 5) may be greater than that illustrated in FIG. 5 due to limitations of mold-forming characteristics.

Similarly, the 1-1 side protrusion portions SPT1-1a and SPT1-1b may each be spaced apart from the 1-2 side protrusion portion SPT1-2 in a diagonal direction in the plan view, and the 2-1 side protrusion portions SPT2-1a and SPT2-1bmay each be spaced apart from the 2-2 side protrusion portion SPT2-2 in a diagonal direction in the plan view.

In embodiments, each of the second bottom protrusion portion BPT2, the 1-2 side protrusion portion SPT1-2, and the 2-2 side protrusion portion SPT2-2 may have a shape in which a chamfered shape or a rounded shape is applied to corner portions in the plan view. In embodiments, shapes in the plan view of the 1-2 side protrusion portion SPT1-2 and the 2-2 side protrusion portion SPT2-2 may be substantially the same as shape in the plan view of each of the first bottom protrusion portions BPT1a and BPT1b, the 1-1 side protrusion portions SPT1-1a and SPT1-1b, and the 2-1 side protrusion portions SPT2-1aand SPT2-1b illustrated in FIG. 3. However, embodiments of the present disclosure are not limited thereto.

Referring to FIG. 5, third bottom protrusion portions BPT3a and BPT3b may be formed in the first area A1, 1-3 side protrusion portions SPT1-3a and SPT1-3b may be formed in the second area A2, and 2-3 side protrusion portions SPT2-3a and SPT2-3b may be formed in the third area A3. As illustrated in FIG. 5, two third bottom protrusion portions BPT3a and BPT3b may be formed, but embodiments of the present disclosure are not limited thereto, and the number of the third bottom protrusion portions BPT3a and BPT3b may be one or three or more.

As illustrated in FIG. 5, two 1-3 side protrusion portions SPT1-3a and SPT1-3b may be formed, but embodiments of the present disclosure are not limited thereto, and the number of the 1-3 side protrusion portions SPT1-3a and SPT1-3b may be one or three or more.

As illustrated in FIG. 5, two 2-3 side protrusion portions SPT2-3a and SPT2-3bmay be formed, but embodiments of the present disclosure are not limited thereto, and the number of the 2-3 side protrusion portions SPT2-3a and SPT2-3b may be one or three or more.

In embodiments, one or more of the first bottom protrusion portions BPT1a and BPT1b may be spaced apart from the second bottom protrusion portion BPT2 by a first separation distance DT1 along the second direction D2. One or more of the 1-1 side protrusion portions SPT1-1a and SPT1-1b may be spaced apart from the 1-2 side protrusion portion SPT1-2 by a second separation distance DT2 along the second direction D2. One or more of the 2-1 side protrusion portions SPT2-1a and SPT2-1b may be spaced apart from the 2-2 side protrusion portion SPT2-2 by a third separation distance DT3 along the second direction D2. The first separation distance DT1, the second separation distance DT2, and the third separation distance DT3 may be substantially the same.

In embodiments, the first separation distance DT1, the second separation distance DT2, and the third separation distance DT3 may be equal to or less than about 2.5 mm. Preferably, the first separation distance DT1, the second separation distance DT2, and the third separation distance DT3 may be equal to or less than about 2 mm. By satisfying the above-described range, a display panel (e.g., the display panel DP of FIG. 1) that is thinner than the first separation distance DT1, the second separation distance DT2, and the third separation distance DT3 may be inserted into the main body portion BP.

In embodiments, the third bottom protrusion portions BPT3a and BPT3b may be spaced apart from the second bottom protrusion portion BPT2 by the first separation distance DT1 along the second direction D2. For example, by spacing the third bottom protrusion portions BPT3a and BPT3b from the second bottom protrusion portion BPT2 by the first separation distance DT1 along the second direction D2, the display panel that is thinner than the first separation distance DT1 may be inserted between the second bottom protrusion portion BPT2 and the third bottom protrusion portions BPT3a and BPT3b.

FIGS. 6, 7, 8, 9, and 10, are views illustrating a method of manufacturing the tray including the main body portion of FIG. 5. Specifically, a perspective view of the main body portion BP illustrated in FIG. 6 illustrates the main body portion BP illustrated in FIG. 5 in a three-dimensional manner. For example, FIGS. 6, 7, 8, 9, and 10, are views illustrating a method of manufacturing the tray (e.g., tray TR of FIG. 1).in which the main body portion BP illustrated in FIG. 5 is folded to form the tray.

Referring further to FIGS. 6 and 7, the main body portion BP may include a plurality of protrusion portions in the first area A1, the second area A2, and the third area A3. As described with reference to FIGS. 3, 4 and 5, a plurality of the protrusion portions may be formed in the main body portion BP. The protrusion portions illustrated in FIGS. 6, 7, 8, 9, 10, 11, and 12, may correspond to the respective protrusion portions illustrated in FIG. 5.

In embodiments, the main body portion BP may be folded along the first folding line FL1 and the second folding line FL2. For example, one surface of the second area A2 of the main body portion BP may be folded along the first folding line FL1 such that the one surface of the second area A2 faces the third direction D3. One surface of the third area A3 of the main body portion BP may be folded along the second folding line FL2 such that the one surface of the third area A3 faces a direction opposite to the third direction D3. Accordingly, the second area A2 and the third area A3 of the main body portion BP may face each other along the third direction D3.

As illustrated in FIG. 7, as the main body portion BP is folded, the first area A1 may be formed into the bottom portion BTP, the second area A2 may be formed into the first side portion SP1, and the third area A3 may be formed into the second side portion SP2. As a result, rather than being separately formed and then assembled, the bottom portion BTP, the first side portion SP1, and the second side portion SP2 of the main body portion BP, may be integrally formed by folding along the first folding line FL1 and the second folding line FL2.

Referring further to FIGS. 8 and 10, the body portion BDP may be located below the main body portion BP. The body portion BDP may include substantially the same material as the main body portion BP. The body portion BDP may have a container shape and cover the main body portion BP illustrated in FIG. 7. For example, the body portion BDP may include plastic and/or the like. However, embodiments of the present disclosure are not limited thereto.

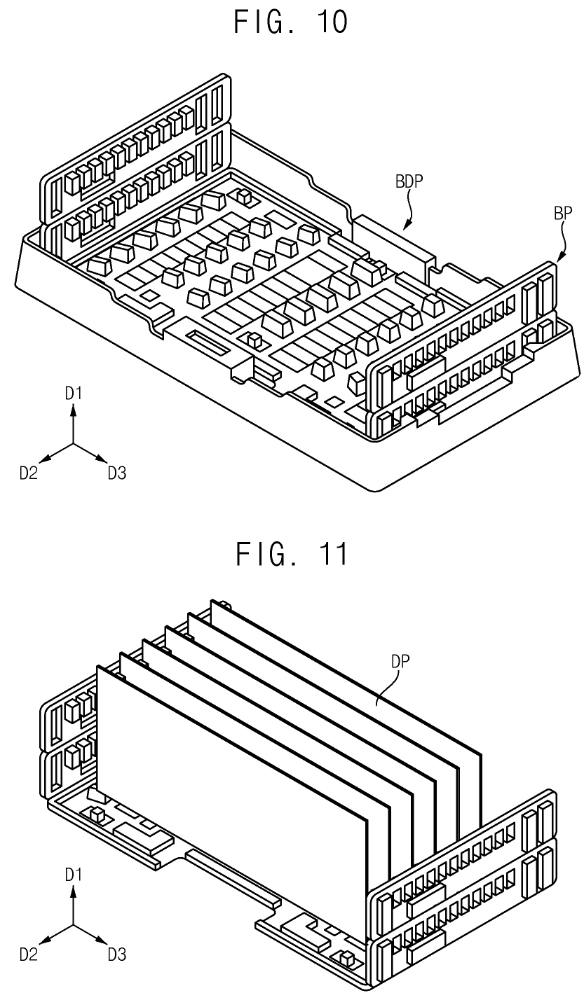

As illustrated in FIG. 9, the main body portion BP may be inserted into the body portion BDP. For example, the main body portion BP illustrated in FIG. 7 may be inserted into the body portion BDP of FIG. 8. By inserting the main body portion BP into the body portion BDP, the first side portion SP1 and the second side portion SP2 of the main body portion BP may be fixed to extend in a first direction D1. For example, the body portion BDP may improve stability when the main body portion BP fixes the display panel (e.g., the display panel DP of FIG. 11) by securing a shape of the main body portion BP.

In the descriptions of the methods and processes herein, the operations may be performed in a different order than the order shown and/or described, or the operations may be performed in different orders or at different times. Certain operations may also be left out of the methods, one or more operations may be repeated, or other operations may be added. Descriptions that an element “may be disposed,” “may be formed,” and the like include methods, processes, and techniques for disposing, forming, positioning, and modifying the element, and the like in accordance with example aspects described herein.

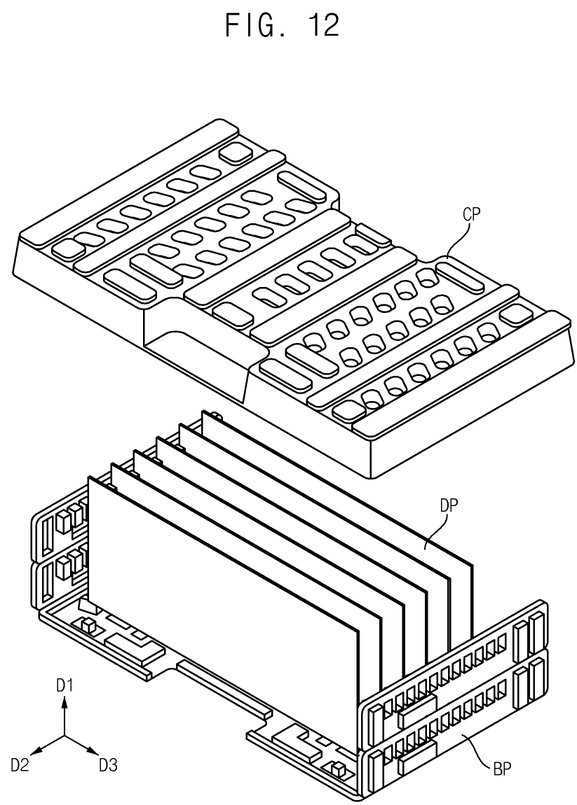

FIG. 11 is a perspective view illustrating embodiments in which a display panel is accommodated by the main body portion illustrated in FIG. 7. FIG. 12 is a perspective view illustrating a tray including a cap portion located on the display panel of FIG. 11.

Referring to FIG. 11, the display panel DP may be inserted into the main body portion BP. For example, the display panel DP may be arranged to form a single column along the second direction D2. The display panel DP may be inserted between the protrusion portions of the main body portion BP.

Referring further to FIGS. 7 and 12, the cap portion CP may be located on an upper portion of the main body portion BP. The cap portion CP may be located on the upper portion of the main body portion BP and protect the display panel DP from external impact or foreign substances. However, the cap portion CP may be omitted.

In embodiments, a height of the side portions SP1 and SP2 of main body portion BP in the first direction D1 may be equal to or greater than about 50% of a length of one side of display panel DP in the first direction D1. Preferably, the height of the side portions SP1 and SP2 of main body portion BP in the first direction D1 may be equal to or greater than about 60% of the length of one side of display panel DP in the first direction D1. By satisfying the above-described range, tray TR may stably accommodate the display device.

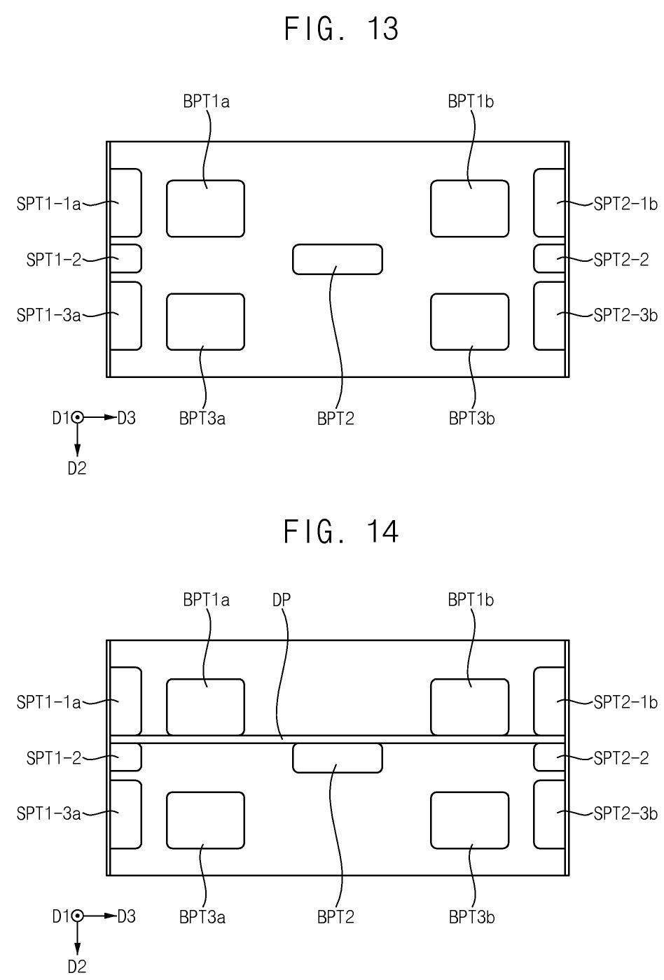

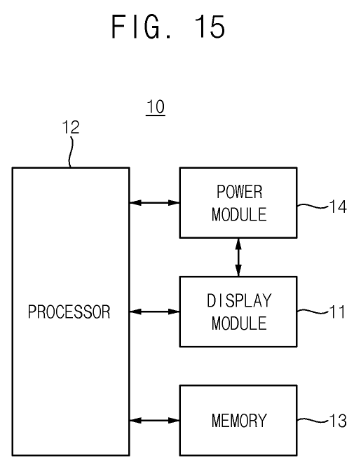

FIG. 13 is a plan view illustrating embodiments of an upper surface of a folded tray. FIG. 14 is a plan view illustrating embodiments in which a display panel is accommodated by the tray of FIG. 13. Specifically, FIG. 14 is a plan view illustrating embodiments in which display panel DP is inserted into main body portion BP of FIG. 11.

Referring to FIGS. 13 and 14, the display panel DP may be inserted between protrusion portions. For example, the display panel DP may be inserted between the first bottom protrusion portions BPT1a and BPT1b and the second bottom protrusion portion BPT2. In some aspects, display panel DP may be inserted between the 1-1 side protrusion portions SPT1-1a and SPT1-1b and the 1-2 side protrusion portion SPT1-2, and may be inserted between the 2-1 side protrusion portions SPT2-1a and SPT2-1b and the 2-2 side protrusion portion SPT2-2.

In the example of FIG. 14, a single display panel DP is illustrated as being inserted, but embodiments of the present disclosure are not limited thereto. A further display panel DP may also be inserted between the second bottom protrusion portion BPT2 and the third bottom protrusion portions BPT3a and BPT3b.

Referring to FIGS. 1, 2, 3, 4, 5, 6, 7, 8, 9, 10, 11, 12, 13, and 14, the display panel DP may be accommodated by protrusion portions formed in the tray TR. Before folding is applied to the tray TR, the protrusion portions are formed in the main body portion BP to allow adjustment of heights of the side portions SP1 and SP2, such that a size of the display panel DP accommodated by the tray TR is not restricted. For example, the position of the first folding line FL1 defined between the first area A1 and the second area A2 and the position of the second folding line FL2 defined between the first area A1 and the third area A3 may be adjustable. Accordingly, when the main body portion BP is folded along the first folding line FL1 and the second folding line FL2, heights of the side portions SP1 and SP2 may be adjusted. In some aspects, as the protrusion portions are formed in a diagonal direction in the plan view, distance constraints between the protrusion portions are minimized, whereby even when the display panel DP has a small thickness, the display panel DP may be stably accommodated by the tray TR.

FIG. 15 is a block diagram illustrating an electronic device according to embodiments.

Referring to FIG. 15, an electronic device 10 may include a display device. The display device may include the display panel (e.g., the display panel DP of FIG. 1). The display device according to embodiments may be applied to various electronic devices 10. The electronic device 10 according to embodiments includes display device described herein, and may further include a module or a device having additional functions other than the display device.

The electronic device 10 according to embodiments may include a display module 11, a processor 12, a memory 13, and a power module 14.

The processor 12 may include at least one of a central processing unit (“CPU”), an application processor (“AP”), a graphic processing unit (“GPU”), a communication processor (“CP”), an image signal processor (“ISP”), and a controller.

Data information supportive of the operation of the processor 12 or the display module 11 may be stored in the memory 15. In an example in which the processor 12 executes an application stored in the memory 15, an image data signal and/or an input control signal is transmitted to the display module 11, and the display module 11 may process received signal and output image information through a display screen.

The power module 14 may include a power supply module such as a power adapter or a battery device, and a power conversion module that converts power supplied by the power supply module to generate power supportive of the operation of the electronic device 10.

At least one of components of the electronic device 10 described herein may be included in the display device according to the above-described embodiments. In some aspects, some of individual modules functionally included in one module may be included in the display device, and others may be provided separately from the display device. For example, the display device may include the display module 11, and the processor 12, the memory 13, and the power module 14 may be provided in form of another device in the electronic device 10 other than the display device.

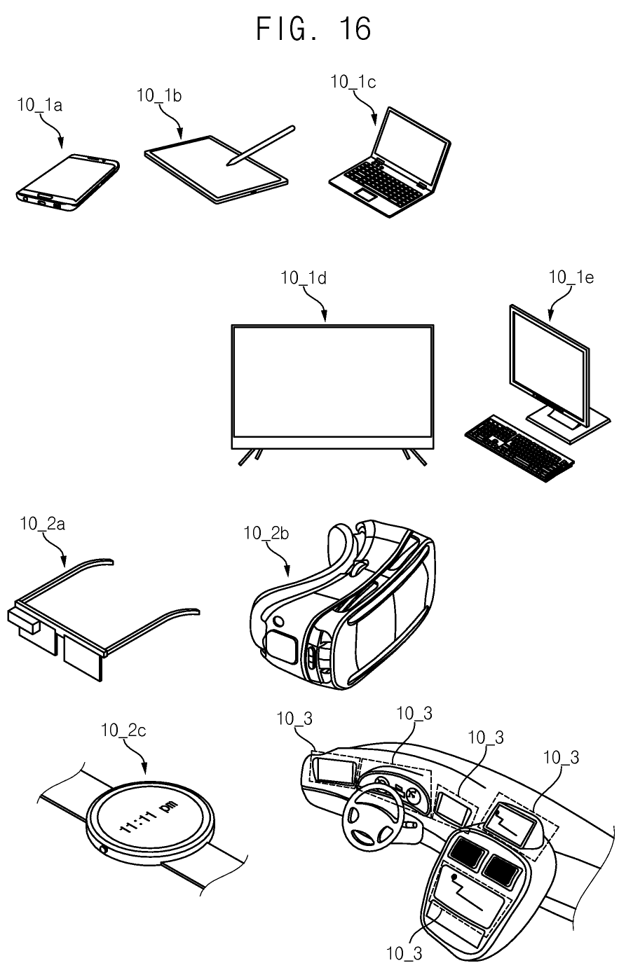

FIG. 16 is a schematic diagram of an electronic device according to various embodiments.

Referring to FIG. 16, various electronic devices to which display devices according to embodiments are applied may include not only electronic devices for image display such as a smartphone 10_1a, a tablet PC 10_1b, a laptop 10_1c, a TV 10_1d, a desk monitor 10_1e, and/or the like, but also wearable electronic devices including display modules such as a smart glass 10_2a, a head mounted display 10_2b, a smart watch 10_2c, and/or the like, vehicle electronic device 10_3 including display modules such as a vehicle's instrument panel, a center fascia, a center information display (“CID”) disposed on a dashboard, a room mirror display, and/or the like.

The present disclosure can be applied to various display devices. For example, the present disclosure is applicable to various display devices such as display devices for vehicles, ships and aircraft, portable communication devices, display devices for exhibition or information transmission, medical display devices, and the like.

The foregoing is illustrative of embodiments and is not to be construed as limiting thereof. Although example embodiments have been described, those skilled in the art will readily appreciate that many modifications are possible in the embodiments without materially departing from the novel teachings and advantages of the embodiments of the present disclosure. Accordingly, all such modifications are intended to be included within the scope of the embodiments of the present disclosure as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A tray which accommodates a display device, the tray comprising:
a bottom portion comprising:
a first bottom protrusion portion protruding in a first direction in a plan view; and
a second bottom protrusion portion protruding in the first direction and spaced apart from the first bottom protrusion portion in a second direction crossing the first direction in the plan view;
a first side portion connected to one side of the bottom portion, the first side portion comprising:
a 1-1 side protrusion portion protruding in a third direction crossing the first direction; and
a 1-2 side protrusion portion spaced apart from the 1-1 side protrusion portion in the second direction; and
a second side portion connected to another side of the bottom portion spaced apart from the one side of the bottom portion, the second side portion comprising:
a 2-1 side protrusion portion protruding in a direction opposite to the third direction; and
a 2-2 side protrusion portion spaced apart from the 2-1 side protrusion portion in the second direction.

2. The tray of claim 1, wherein the first bottom protrusion portion and the second bottom protrusion portion are spaced apart from each other in a diagonal direction in the plan view.

3. The tray of claim 1, wherein a first separation distance by which the first bottom protrusion portion and the second bottom protrusion portion are spaced apart in the second direction is equal to or less than about 2.5 mm.

4. The tray of claim 3, wherein:
the 1-1 side protrusion portion and the 1-2 side protrusion portion are spaced apart by a second separation distance in the second direction, and
the 2-1 side protrusion portion and the 2-2 side protrusion portion are spaced apart by a third separation distance in the second direction.

5. The tray of claim 4, wherein the first separation distance, the second separation distance, and the third separation distance are substantially equal to each other.

6. The tray of claim 3, wherein the bottom portion further comprises a third bottom protrusion portion which is spaced apart from the second bottom protrusion portion in the second direction and parallel to the first bottom protrusion portion along the second direction.

7. The tray of claim 6, wherein the third bottom protrusion portion is spaced apart from the second bottom protrusion portion by the first separation distance in the second direction.

8. The tray of claim 1, wherein a height of each of the first side portion and the second side portion in the first direction is equal to or more than about 50% of a length of one side of the display device.

9. The tray of claim 1, wherein the bottom portion, the first side portion, and the second side portion are integrally formed.

10. The tray of claim 1, further comprising:
a body portion located below the bottom portion and covering the bottom portion, the first side portion, and the second side portion.

11. The tray of claim 10, wherein the bottom portion, the first side portion, the second side portion, and the body portion comprise plastic.

12. The tray of claim 1, wherein each of the first bottom protrusion portion and the second bottom protrusion portion has a chamfered corner in the plan view.

13. The tray of claim 1, wherein the tray accommodates the display device between the first bottom protrusion portion and the second bottom protrusion portion.

14. A method of manufacturing a tray, the method comprising:
providing a main body portion comprising a first area, a second area located adjacent to one side of the first area, and a third area located adjacent to another side of the first area;
forming a first bottom protrusion portion, a 1-1 side protrusion portion, and a 2-1 side protrusion portion in the first area, the second area, and the third area of the main body portion, respectively, wherein the first bottom protrusion portion, the 1-1 side protrusion portion, and the 2-1 side protrusion portion are parallel to each other along a first direction;
forming a second bottom protrusion portion in the first area of the main body portion, the second bottom protrusion portion being spaced apart from the first bottom protrusion portion in a second direction crossing the first direction;
forming a 1-2 side protrusion portion in the second area of the main body portion, the 1-2 side protrusion portion being spaced apart from the 1-1 side protrusion portion in the second direction;
forming a 2-2 side protrusion portion in the third area of the main body portion, the 2-2 side protrusion portion being spaced apart from the 2-1 side protrusion portion in the second direction; and
folding the main body portion along a first folding line dividing the first area and the second area and a second folding line dividing the first area and the third area.

15. The method of claim 14, wherein based on the folding of the main body portion:
the first area of the main body portion is formed into a bottom portion,
the second area of the main body portion is formed into a first side portion, and
the third area of the main body portion is formed into a second side portion facing the first side portion.

16. The method of claim 14, wherein the forming of the first bottom protrusion portion, the second bottom protrusion portion, the 1-1 side protrusion portion, the 1-2 side protrusion portion, the 2-1 side protrusion portion, and the 2-2 side protrusion portion comprises a mold-forming process.

17. The method of claim 16, wherein based on the mold-forming process each of the first bottom protrusion portion, the second bottom protrusion portion, the 1-1 side protrusion portion, the 1-2 side protrusion portion, the 2-1 side protrusion portion, and the 2-2 side protrusion portion has a shape with a chamfered corner in a plan view.

18. The method of claim 17, wherein based on the mold-forming process:
the first bottom protrusion portion and the second bottom protrusion portion are spaced apart by a first separation distance in the second direction,
the 1-1 side protrusion portion and the 1-2 side protrusion portion are spaced apart by a second separation distance in the second direction, and
the 2-1 side protrusion portion and the 2-2 side protrusion portion are spaced apart by a third separation distance in the second direction.

19. The method of claim 18, wherein each of the first separation distance, the second separation distance, and the third separation distance is equal to or less than about 2.5 mm.

20. An electronic device comprising:
a display device; and
a processor driving the display device, wherein:
the display device is accommodated by a tray, the tray comprising:
a bottom portion comprising:
a first bottom protrusion portion protruding in a first direction; and
a second bottom protrusion portion protruding in the first direction and spaced apart from the first bottom protrusion portion in a second direction crossing the first direction in a plan view;
a first side portion connected to one side of the bottom portion, the first side portion comprising:
a 1-1 side protrusion portion protruding in a third direction crossing the first direction; and
a 1-2 side protrusion portion spaced apart from the 1-1 side protrusion portion in the second direction; and
a second side portion connected to another side of the bottom portion spaced apart from the one side of the bottom portion, the second side portion comprising:
a 2-1 side protrusion portion protruding in a direction opposite to the third direction; and
a 2-2 side protrusion portion spaced apart from the 2-1 side protrusion portion in the second direction.
